(19) United States
(12) Patent Application Publication
(10) Pub. No.: US 2018/0295158 A1
(43) Pub. Date: Oct. 11, 2018

(54) DISPLAYING GROUP EXPRESSIONS FOR TELECONFERENCE SESSIONS

(71) Applicant: Microsoft Technology Licensing, LLC, Redmond, WA (US)

(72) Inventor: Jason Thomas Faulkner, Seattle, WA (US)

(21) Appl. No.: 15/480,339

(22) Filed: Apr. 5, 2017

(51) Int. Cl. H04L 29/06; G06F 3/0481; G06F 3/0484

(52) U.S. Cl. CPC H04L 65/1059; G06F 3/04847; G06F 3/04817; H04L 65/403

(57) ABSTRACT

Systems and methods for displaying group expressions made during a teleconference session are presented. A system can be configured to provide different expressions of a group expression view in response to receiving the same indication of expression from a number of computing devices that exceed a threshold. For instance, in response to receiving an indication of a first expression from at least the threshold number of computing devices, a teleconference system can generate a group expression view that provides users with an indication of the group expression. The display characteristics of the group expression view can be changed based on a number of users providing the indication of the expression.

### BACKGROUND

The use of teleconference systems in commercial and corporate settings for facilitating meetings and conferences between users (i.e., people) in remote locations has increased dramatically. In general, teleconference systems allow users, in two or more remote locations, to interactively communicate with each other via live, simultaneous two-way video streams, audio streams, or both. Some teleconference systems (such as, for example, Cisco Web Ex provided by Cisco Systems, Inc. of San Jose, Calif., GoToMeeting provided by Citrix Systems, Inc. of Santa Clara, Calif., Zoom provided by Zoom Video Communications of San Jose, Calif., Google Hangouts by Alphabet Inc. of Mountain View, Calif., and Skype® provided by Microsoft Corporation, of Redmond, Wash.) also allow users to exchange digital documents such as, for example, images, text, video and any others.

A limitation of teleconference systems is that they do not allow remote users to experience the typical interactions that occur at live meetings or conferences when all the users are physically present at the same location. Most teleconference systems utilize remote communication devices (e.g., personal computing devices and mobile computing devices) that have a limited display area. Typically, the remote users of the teleconference system are limited to viewing the interactions of the meeting, or conference, through a “window” of the meeting, or conference, produced by the video display, which may be the screen of a mobile device, computer monitor, or large video display.

The limited display area results in a user interface that produces a flat “thumbnail” style people and content experience for the remote users of the teleconference system attending the meeting or conference. Generally, this user interface only allows users to see a limited number of framed users (i.e., other people attending the meeting or conference) in a gallery. In some cases, the users may see the most active users of a teleconference but are not able to see other users of the teleconference. For example, in a teleconference that includes a large number of users (e.g., more than just a few active users that can be shown within the display area), the users are not able to view what the non-active users are doing during the teleconference. Further, the users of the teleconference may not be aware of expressions of emotion (hereinafter “expression”) that are made by the non-active users. This can result in the non-active users feeling unengaged and the active users being unaware of reactions to content presented during a teleconference. As such, there is a need for an improved teleconference system that addresses these issues. It is with respect to these and other considerations that the disclosure made herein is presented.

### SUMMARY

The techniques disclosed herein provide for the display of group expressions for teleconference sessions. Using the techniques described herein, a teleconference system determines that an indication of an expression (e.g., clapping, waving, smiling, frowning, raising a hand, agreeing, disagreeing, and the like) is provided by a group of users participating in the conference. For example, the system can identify that a group of users participating in a teleconference session have provided an indication of an expression associated with “clapping”. In response to identifying that the group of users has provided the same indication of expression, the system provides for a display of one or more graphical elements that indicate the group expression. In this way, in some configurations, the users participating in the teleconference session can see when a group of the users are providing the same indication of expression, such as “clapping”, at or near the same time during the teleconference session. In some configurations, the system can indicate when a group of users are providing indications of different expressions. Depending on the number of expressions of a group, different graphical elements and/or graphical properties are displayed or used modified to indicate the number of expressions. As described herein, a “group expression” can refer to an indication of an expression made by a threshold number (e.g., two, three, eight, one hundred, . . . ) of users participating in the teleconference session.

During a teleconference session, users might indicate an expression by selecting a graphical user interface element, a menu item, using speech, or provide the indication of an expression using some other method. In some configurations, a menu item may be selected by a user to provide an indication that the user is: smiling; frowning; clapping; raising a hand; agreeing; disagreeing, indicating that they will be right back or can't hear; and the like. In some cases, more than one user may provide the indication of the expression, such as clapping, at the same time as another user, or at a time proximate to the other users providing the indication of the same expression. The system receives the indication of the expression (e.g., “clapping”) from each of the different users and determines that the number of users is above a threshold number of users. When the number of users is above the threshold number, the system provides for display of the indication of the expression as one or more group expression graphical elements to the users participating in the teleconference session.

In some examples, the system causes a display of a group expression that includes a display of one or more graphical user interface elements that provide an indication that a group of users have provided the same indication of expression (e.g., a group of users provided a clapping expression). The number of displayed elements may indicate, or correspond to, a number of users indicating an expression. The number of displayed elements may increase to a second threshold, also referred to herein as a growth threshold. In some configurations, once the number of users indicating expression reaches the growth threshold, the display characteristics associated with the display of the group expression graphical element can change based on the number of users providing the indication of the expression. For example, when the group includes a number of users that exceeds a first threshold (e.g., two, three, four, . . . ), but is below a second threshold, the group expression can be displayed using a graphical user interface element with a first set of display characteristics (e.g., size, color, animation effect). When the group size providing the input of expression exceeds the second threshold, one or more of the display characteristics of the graphical user interface element may be changed and/or one or more additional graphical user interface elements can be displayed or adjusted. As an example, when the number of users in the group is less than the second threshold (e.g., three, four, . . . ) the system can provide graphical data within a display of a graphical user interface element that indicates an identity of each of the users providing the indication of the expression. In some cases, the system provides a few frames of video received from the camera of each of the users. In other cases, the system provides an avatar that represents the user within the graphical user interface element. During the time of the group expression, the teleconference system can provide for display of a representation of the users that provided the indication of the expression along with an emoticon that graphically represents the indication of the expression.

As briefly mentioned, when the number of users within the group providing the indication of the expression exceed the second threshold, the teleconference system can change display characteristics of the group expression and/or provide some other display effects. For example, one or more display characteristics of the graphical user interface element can be changed. The display characteristics that can change include, but are not limited to, a size of the graphical user interface element, a color of the graphical user interface element, a position of the graphical user interface element, and the like.

In some cases, an animation effect can be used in addition to, or in place of any change to the display characteristics of the graphical user interface element. For example, the animation effect could show the graphical user interface increasing from a small size to a larger size and back to a smaller size. The change to the display characteristics can be based on the number of users providing the indication of the expression. For example, as the number of users providing the same indication of expression increases, a rate at which the animation occurs can increase. Similarly, when the number of users providing the same indication of expression decreases, the rate can decrease. Generally, any animation effect can be provided. When the system detects that the indication of the expression is no longer being received from the group of users, the graphical user interface element indicating the group expression is removed. For example, the group expression can be removed after not receiving the indication of expression from the users for some period of time (e.g., a timeout period).

During a teleconference session, streams are received from a plurality of client computing devices at a server. The streams can be combined by the server to generate teleconference data defining aspects of a teleconference session. The teleconference data can comprise individual data streams, also referred to herein as “streams,” which can comprise content streams or participant streams. The participant streams include video of one or more users that are participating in the teleconference. The content streams may include video or images of files, data structures, word processing documents, formatted documents (e.g. PDF documents), spreadsheets, or presentations. The content streams include streams that are not participant streams. In some configurations, the participant streams can include video data, and in some configurations audio data, streaming live from a video camera connected to a user's client computing device. In some instances, a user may not have access to a video camera and may communicate a participant stream comprising an image of the user, or an image representative of the user, such as, for example, an avatar. The teleconference data and/or the streams of the teleconference data can be configured to cause a computing device to generate a user interface comprising a display area for rendering one or more streams of the teleconference data.

The teleconference data is configured to cause at least one client computing device of the plurality of client computing devices to render a first user interface that displays one or more of the streams within a first view (the “stage view”). The teleconference data can also include data that when rendered by a client computing device provides a display of one or more “group expression” graphical elements that indicates the group expression(s) indicated during the teleconference session. The group expression user interface element(s) can be displayed concurrently with the stage view, or some other view, such that the users stay informed about what the users not shown within the stage view are feeling during the teleconference.

The teleconference system may provide users with many different tools for providing indications of expressions. For example, the teleconference system may provide a graphical user interface that allows a participant to select from a group of emojis to provide an indication of an expression of a user. For example, the emojis might indicate smiling, frowning, clapping, be right back, can't hear, raising a hand, agreeing, disagreeing, and the like.

Enabling a user of a teleconference session to view group expressions keeps users engaged in the session by enabling users not only to see active participants of the teleconference but also to see how the non-active participants are reacting to the content presented during the teleconference.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

FIG. 1 is a block diagram of an example of a teleconference system.

FIG. 2 is a block diagram of an example of the device in the teleconference system of FIG. 1.

FIG. 3A is a screenshot view of a display corresponding to one of the client computing devices in a teleconference session illustrating a stage view and a group expression.

FIG. 3B is a screenshot view of a display corresponding to one of the client computing devices in a teleconference session illustrating a stage view showing two group expressions.

FIG. 3C is a screenshot view of a display corresponding to one of the client computing devices in a teleconference session illustrating a stage view and group expressions associated with the same indication of expression.

FIG. 3D is a screenshot view of a display corresponding to one of the client computing devices in a teleconference session illustrating a stage view and a group expression that includes displaying a representation of users providing the indication of the expression.

FIGS. 3E and 3F are screenshot views of a display corresponding to one of the client computing devices in the teleconference session illustrating the teleconference monitor view including one and two group expressions.

FIGS. 3G, 3H, and 3I are screenshot views of a display corresponding to one of the client computing devices in the teleconference session illustrating the teleconference monitor view including one, two, and three group expressions.

FIGS. 3J, 3K, and 3L are screenshot views of a display corresponding to one of the client computing devices in the teleconference session illustrating the teleconference monitor view including a group expression and depicting a graphical representation of the users providing an indication of the expression.

FIGS. 3M, 3N, 3O, and 3P are screenshot views of a display corresponding to one of the client computing devices in the teleconference session illustrating a view including a group expression, a display of non-active users, and a depiction of a graphical representation of the users providing an indication of the expression.

FIG. 4 is a flowchart illustrating an operation for presenting a group expression on a display of a client computing device as in the example teleconference system of FIG. 1.

### DETAILED DESCRIPTION

Examples described below enable a system to provide for the display of group expressions made during a teleconference session at a client computing device. The teleconference session may be controlled at a teleconference server connected to a plurality of client computing devices participating in the teleconference session. The client computing devices may be configured to allow a user to provide an indication of an expression and to view group expressions made during a teleconference session.

In an example implementation, the teleconference session involves participant streams received from client computing devices associated with the users participating in the teleconference. The participant streams include video, audio, and/or image data that identify or represent the users in a display of the teleconference session at the client computing devices. The teleconference session may also receive content streams from one or more client computing devices, or from another source. The content streams include streams that are not participant streams. In some configurations, the content streams include video or image data of files, data structures, word processing documents, formatted documents (e.g. PDF documents), spreadsheets, or presentations to be presented to, and thereby shared with, the users in the display of the teleconference session. The teleconference session at the server combines the streams to generate teleconference data and transmits the teleconference data to each client computing device according to a teleconference session view configured for each client computing device.

The teleconference session view may be tailored for each client computing device using one of several different views. As discussed briefly above, for a given client computing device, the teleconference session view may be in a first user interface referred to herein as a stage view, or a second user interface referred to herein as a teleconference monitor view. According to some configurations, the stage view provides a total display experience in which either people or content is viewed “on stage,” which is a primary display area of an interface. In some configurations, the primary display area of a user interface can be displayed in a manner that dominates the display on a user's client computing device. The stage view allows a user to be fully immersed with the content being shared among the teleconference participants. User interface elements associated with the stage view can be used to display streams that correspond to participants and the content that is not being displayed on stage and/or otherwise control operations relating to the display of the stage view.

In some implementations, the stage view may be displayed in one of two display modes. A first display mode is a “windowed mode,” which includes a frame around the primary display area, wherein the frame comprises control user interface elements for controlling aspects of the windows, such as minimizing, maximizing, or closing the user interface. The stage view may also be displayed in an “immersive mode,” which does not include a frame. In the immersive mode, the primary display area can occupy the entire display area of a device.

In the stage view, content or at least some of the users participating in the teleconference session are displayed in the primary display area that occupies at least a majority of the display area. In some configurations, the stage view may be changed to another view. For example, the system can cause a display of a teleconference monitor view to display one or more streams of the teleconference session. In some configurations, the teleconference monitor view is a display of one or more thumbnail sized user interface elements that are configured to display renderings of at least a portion of one or more of the streams. For example, a thumbnail can be configured to display a rendering of the active speaker and/or the content currently being displayed within the teleconference session. In some instances, one or more other thumbnail user interface elements can be configured to display a rendering of a camera view of what the participant is currently providing to the teleconference service, and/or other content associated with the teleconference session. The teleconference monitor view can be displayed such that the user stays engaged with the teleconference session even though the teleconference monitor view does not include as much content as compared to the stage view.

Regardless of whether the stage view, the teleconference monitor view, or some other view is displayed, a group expression indicating that a group of users participating in the teleconference session have provided the same indication of an expression can be displayed within one or more graphical elements. For example, an area of a particular view can be designated to display group expressions and/or the location of the display of the group expression can be selected based on what other content is currently being displayed.

As briefly discussed, user interface elements can be provided to allow a user to select and provide an indication of an expression. User interface elements can also be selected by a user to switch between different views. In example implementations as described below, the user interface elements allow the user to select an emoji or an emoticon during a teleconference to provide an indication of an expression. Generally, an “emoji” is an image representing an expression and an “emoticon” is a series of characters that represent an expression (e.g., “:)” for indicating a smile). The terms “emoji”, and “emoticon” may be used interchangeably herein. In some configurations, the user interface elements might allow a user to select a smiley face emoji, a frowning face emoji, a clapping emoji, or some other emoji. Generally, the user interface elements can allow the user to select any available emoji. In other examples, the user can type the characters to create the emoticon to represent the expression.

User interface elements can also be used to allow a user to switch between the stage view and the other views. The user may be provided with tools to switch between the views to alter the user's experience of the teleconference session. For illustrative purposes, the terms “user” and “participant” are used interchangeably and in some scenarios the terms have the same meaning. In some scenarios, a user is associated with and interacting with a computer. A participant, for example, can be a user of a computer viewing and providing input to a teleconference session.

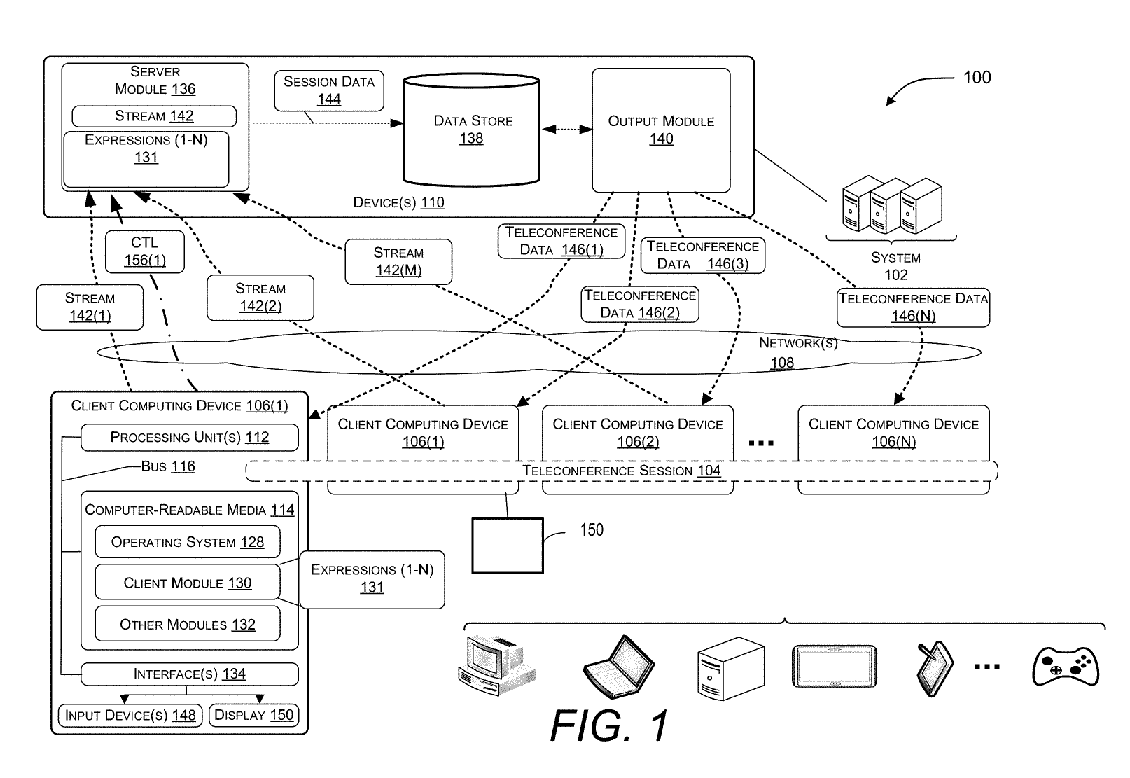

In FIG. 1, a diagram illustrating an example of a teleconference system 100 is shown in which a system 102 can provide an indication of group expressions with views for a teleconference session 104 in accordance with an example implementation. In this example, the teleconference session 104 is between a number of client computing devices 106(1) through 106(N) (where N is a positive integer number having a value of two or greater). The client computing devices 106(1) through 106(N) enable users to participate in the teleconference session 104. In this example, the teleconference session 104 may be hosted, over one or more network(s) 108, by the system 102. That is, the system 102 may provide a service that enables users of the client computing devices 106(1) through 106(N) to participate in the teleconference session 104. As an alternative, the teleconference session 104 may be hosted by one of the client computing devices 106(1) through 106(N) utilizing peer-to-peer technologies.

The system 102 includes device(s) 110, and the device(s) 110 and/or other components of the system 102 may include distributed computing resources that communicate with one another, with the system 102, and/or with the client computing devices 106(1) through 106(N) via the one or more network(s) 108. In some examples, the system 102 may be an independent system that is tasked with managing aspects of one or more teleconference sessions 104. As an example, the system 102 may be managed by entities such as SLACK®, WEBEX®, GOTOMEETING®, GOOGLE HANGOUTS®, etc.

Network(s) 108 may include, for example, public networks such as the Internet, private networks such as an institutional and/or personal intranet, or some combination of private and public networks. Network(s) 108 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 108 may utilize communications protocols, including packet-based and/or datagram-based protocols such as Internet protocol (“IP”), transmission control protocol (“TCP”), user datagram protocol (“UDP”), or other types of protocols. Moreover, network(s) 108 may also include a number of devices that facilitate network communications and/or form a hardware basis for the networks, such as switches, routers, gateways, access points, firewalls, base stations, repeaters, backbone devices, and the like.

In some examples, network(s) 108 may further include devices that enable connection to a wireless network, such as a wireless access point (“WAP”). Example networks support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, and so forth), and other standards.

In various examples, device(s) 110 may include one or more computing devices that operate in a cluster or other grouped configuration to share resources, balance load, increase performance, provide fail-over support or redundancy, or for other purposes. For instance, device(s) 110 may belong to a variety of classes of devices such as traditional server-type devices, desktop computer-type devices, and/or mobile-type devices. Thus, although illustrated as a single type of device—a server-type device—device(s) 110 may include a diverse variety of device types and are not limited to a particular type of device. Device(s) 110 may represent, but are not limited to, server computers, desktop computers, web-server computers, personal computers, mobile computers, laptop computers, mobile phones, tablet computers, or any other sort of computing device.

A client computing device (e.g., one of client computing device(s) 106(1) through 106(N)) may belong to a variety of classes of devices, which may be the same as, or different from, device(s) 110, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a teleconference device, a computer navigation type client computing device such as a satellite-based navigation system including a global positioning system (“GPS”) device, a wearable device, a virtual reality (“VR”) device, an augmented reality (AR) device, an implanted computing device, an automotive computer, a network-enabled television, a thin client, a terminal, an Internet of Things (“IoT”) device, a work station, a media player, a personal video recorder (“PVR”), a set-top box, a camera, an integrated component (e.g., a peripheral device) for inclusion in a computing device, an appliance, or any other sort of computing device. In some implementations, a client computing device includes input/output (“I/O”) interfaces that enable communications with input/output devices such as user input devices including peripheral input devices (e.g., a game controller, a keyboard, a mouse, a pen, a voice input device, a touch input device, a gestural input device, and the like) and/or output devices including peripheral output devices (e.g., a display, a printer, audio speakers, a haptic output device, and the like).

Client computing device(s) 106(1) through 106(N) of the various classes and device types can represent any type of computing device having one or more processing unit(s) 112 operably connected to computer-readable media 114 such as via a bus 116, which in some instances can include one or more of a system bus, a data bus, an address bus, a PCI bus, a Mini-PCI bus, and any variety of local, peripheral, and/or independent buses. The computer-readable media 114 may store executable instructions and data used by programmed functions during operation. Examples of functions implemented by executable instructions stored on the computer-readable media 114 may include, for example, an operating system 128, a client module 130, other modules 132, and, programs or applications that are loadable and executable by processing units(s) 112.

Client computing device(s) 106(1) through 106(N) may also include one or more interface(s) 134 to enable communications with other input devices 148 such as network interfaces, cameras, keyboards, touch screens, and pointing devices (mouse). For example, the interface(s) 134 enable communications between client computing device(s) 106(1) through 106(N) and other networked devices, such as device(s) 110 and/or devices of the system 102, over network(s) 108. Such network interface(s) 134 may include one or more network interface controllers (NICs) or other types of transceiver devices to send and receive communications and/or data over a network.

In the example environment 100 of FIG. 1, client computing devices 106(1) through 106(N) may use their respective client modules 130 to connect with one another and/or other external device(s) in order to participate in the teleconference session 104. For instance, a first user may utilize a client computing device 106(1) to communicate with a second user of another client computing device 106(2). When executing client modules 130, the users may share data, which may cause the client computing device 106(1) to connect to the system 102 with the other client computing devices 106(2) through 106(N) over the network(s) 108.

The client module 130 of each client computing device 106(1) through 106(N) may include logic that detects user input and communicates control signals to the server relating to controlling aspects of the teleconference session 104. For example, the client module 130 in the first client computing device 106(1) in FIG. 1 may detect a user input at an input device 148. The user input may be sensed, for example, as a finger press on a user interface element displayed on a touchscreen, or as a click of a mouse on a user interface element selected by a pointer on the display 150. The client module 130 translates the user input according to a function associated with the selected user interface element.

As discussed above, the user input can include a selection relating to providing an indication of an expression (e.g., selection of an emoji) or changing the display of content associated with the teleconference session 104. The client module 130 may send a control signal 156(1) (also referred to herein as a “control command” or an “indication”) to a server (for example, a server operating on the device 110) to perform the desired function. In some examples, the client module 130 may send a control signal to a server indicating that the user has provided an indication of an expression.

In one example function, the user of the client computing device 106(1) may wish to provide an indication of an expression during the teleconference session 104. For instance, a user may desire to indicate a “smile”, a “frown”, “clapping”, a “gasp”, or some other indication of an expression during the teleconference session. As an example, the user may select an emoji from a graphical user interface element to provide the system with during the teleconference session 104. Using techniques described herein, the user of the client computing device 106(1) can input indications of expressions and view group expressions made during the teleconference session 104. As illustrated, the client module 130 can be associated with different indications of expressions (1-N) 131. The client module can be used to identify the selection of one or more user interface elements that are provided by the teleconference system 102 via the server module 136 to represent an expression.

As discussed above, the teleconference service may receive an indication of an expression from one or more of the client computing devices 106. For example, a user participating in the teleconference session 104 may have selected a graphical user interface element, or a menu item representing an expression. The user could also have provided input of the indication of the expression via some other input device, such as, but not limited to a keyboard, a speech input device, a gesture recognition device, and the like.

In some configurations, the user can select via user interface elements an emoji representing an expression that the user is: smiling; frowning; clapping; raising a hand; agreeing; disagreeing, indicating that they will be right back or can't hear; and the like. In other examples, more or less representation of expressions can be provided. In some cases, the system 102 detects that more than one client computing device 106 provides the same indication of the expression during some period of time. For example, multiple users may provide the same indication of expression within some predetermined period of time (e.g., one second, two seconds, five seconds, . . . ).

The system 102 receives the indication of the expression (e.g., “clapping”) from each of the different client computing devices 106 associated with the users participating in the teleconference session and determines whether the number of users providing the indication of the expression is above a threshold number of users (e.g., >2 or some other number of users). The system 102 then generates teleconference data 146 that when displayed provides the indication of the expression as a group expression to the users participating in the teleconference session 104.

In some examples, the system 102 generates teleconference data 146 that when displayed by a client computing device 106 illustrates a group expression. The system 102 may generate teleconference data associated with one or more graphical user interface elements that provide the display of the group expression. For example, different graphical user interface elements can be displayed in response to detecting different indications of expression made by users participating in the teleconference session 104.

In some configurations, the system 102 changes the display characteristics of the group expression based on the number of users providing the indication of the expression. For example, when the server module 136 determines that the number of users providing the indication of the expression exceeds a first threshold (e.g., two, three, four, . . . ), but is below a second threshold, (e.g., three, four . . . ) the system 102 generates teleconference data 146 that is associated with a first set of display characteristics (e.g., size, color, animation effect). When the server module 136 determines that the group of users providing the indication of expression exceeds the second threshold, the system 102 generates teleconference data 146 that changes one or more of the display characteristics of the graphical user interface element and/or displays one or more additional graphical user interface elements. As an example, when the server module 136 determines that the number of users in the group is less than the second threshold (e.g., three, four, . . . ) the system 102 can generate teleconference data 146 that is displayed within a graphical user interface element that indicates an identity of each of the users providing the indication of the expression. In some cases, the system 102 provides data including a few frames of video received from the camera of each of the users providing the indication of the expression. In other cases, the system 102 provides an avatar that represents the user within the graphical user interface element. During the time of the group expression, the system 102 can provide for display a representation of the users that provided the indication of the expression along with an emoticon that graphically represents the indication of the expression.

According to some examples, when the system 102 determines that the number of users within the group providing the indication of the expression exceed the second threshold, the system 102 changes the display characteristics of the group expression and/or provides some other display effects. The display characteristics that can change include, but are not limited to a size of the graphical user interface element, a color of the graphical user interface element, a position of the graphical user interface element, and the like.

In some cases, the system 102 generates teleconference data 146 to provide an animation effect of the group expression. For example, the animation effect can be generated by the system 102 to show the graphical user interface associated with the indication of expression increasing from a smaller size to a larger size and back to a smaller size. Generally, any animation effect can be provided. When the system 102 detects that the indication of the expression is no longer being received from the group of users, the graphical user interface element(s) indicating the group expression is no longer shown. For example, the group expression can be removed after not receiving the indication of expression from the users for some period of time (e.g., a timeout period).

According to some examples, the location of where to render the group expression can be based on content currently displayed. In some configurations, the server module 136 of the teleconference service can position the group expression on the display 150 based on knowledge of the locations of the displayed user interface elements and content within the user interfaces associated with the selected category of functionality. For example, when the user is viewing the stage view, the group expression graphical user interface element may be placed within or near an overflow area. In some configurations, an “overflow area” is used to indicate the number of users that are participating in the teleconference session 104 but are not currently being shown within the stage view or one of the primary views associated with the teleconference session 104. In other examples, the group expression view can be displayed on an area of the display that does not include selectable user interface elements. In other configurations, the group expression view can be placed in a predetermined position.

In some configurations, the location of the group expression can be based on an analysis of the content that is currently displayed. According to some techniques, the teleconference system performs an analysis of graphical data rendered on the display 150 to identify areas on the display that do not include selectable user interface elements (e.g., control buttons, selectors, scroll bars, and the like) or are areas of the display 150 that do not include other types of content that the user may want to view (e.g., text, drawings, graphs). For instance, the server module 136 can obtain a screenshot of the display 150 and perform an edge detection mechanism, a histogram, or some other technique to identify areas on the display 150 that include selectable user interface elements as well as identify areas on the display that include other graphical content. When there is an area identified to not include user interface controls and/or other content, the server module 136, and or the client module 130, or some other component, can determine the location on the display 150 at which to render the group expression.

As discussed above, the teleconference session views can include a stage view that includes a display area for participants and content. In some examples, the stage view is the main view. When the user decides to switch views, the stage view may be removed from the display and/or hidden from view (or at least partially obscured) and another view can be presented.

Instead of the user not being able to view content or people associated with the teleconference session 104 when the user navigates away from the stage view by selecting a different view, the teleconference system 102 can present a teleconference monitor view (e.g., one or more thumbnail user interface elements) that provides a rendering of at least one teleconference stream 142. For example, the teleconference monitor view can display the current presenter, and/or other content. In some instances, the teleconference monitor view includes a thumbnail view of the current presenter and/or content being presented. According to some configurations, a portion of the teleconference monitor view displays a video stream 142 of the user's camera view when the user is sharing a camera view. In addition to displaying content relating to an active user participating in the teleconference, the teleconference system 102 can display one or more graphical user interfaces relating to the group expression.

The stage view and the other views can also include graphical elements providing control functionality (“control elements”) for a teleconference session 104. For instance, a graphical element may be generated on the user interface enabling a user to provide content, end a session, mute one or more sounds, return to the stage view, provide an indication of an expression, and the like.

As discussed above, in response to a group of users providing a same indication of an expression during some period of time, the system 102 detects the indication of the expression (e.g., via the CTL 156(1) signal) received from multiple client computing devices 106 and causes the group expression view to be presented on the display 150. According to some techniques, the client module 130 may identify the selection of a user interface element to select an indication of an expression and sends a control signal 156(1) to a teleconference session 104 host. Upon determining that a group expression has been indicated by a threshold number of users, the server module 136 can determine the display characteristics of the group expression view and the location on the display 150 where to render the group expression view, generate the teleconference stream associated with the group expression view, and cause the teleconference stream 142 to be rendered on the display 150.

The client computing device(s) 106(1)-106(N) may use their respective client modules 130, or some other module (not shown) to generate participant profiles, and provide the participant profiles to other client computing devices 106 and/or to the device(s) 110 of the system 102. A participant profile may include one or more of an identity of a participant (e.g., a name, a unique identifier (“ID”), etc.), participant data, such as personal data and location data which may be stored. Participant profiles may be utilized to register participants for teleconference sessions 104.

As shown in FIG. 1, the device(s) 110 of the system 102 includes a server module 136, a data store 138, and an output module 140. The server module 136 is configured to receive, from individual client computing devices 106(1) through 106(N), streams 142(1) through 142(M) (where M is a positive integer number equal to 2 or greater). In some scenarios, not all the client computing devices utilized to participate in the teleconference session 104 provide an instance of streams 142, and thus, M (the number of instances submitted) may not be equal to N (the number of client computing devices). In some other scenarios, one or more of the client computing devices 106 may be communicating an additional stream 142 that includes content, such as a document or other similar type of media intended to be shared during the teleconference session 104.

The server module 136 is also configured to receive, generate and communicate session data 144 and to store the session data 144 in the data store 138. The session data 144 can define aspects of a teleconference session 104, such as the identities of the participants, the content that is shared, etc. In various examples, the server module 136 may select aspects of the streams 142 that are to be shared with the client computing devices 106(1) through 106(N). The server module 136 may combine the streams 142 to generate teleconference data 146 defining aspects of the teleconference session 104. The teleconference data 146 can comprise individual streams containing select streams 142. The teleconference data 146 can define aspects of the teleconference session 104, such as a user interface arrangement of the user interfaces on the client computing devices 106, the type of data that is displayed and other functions of the server and client computing devices. The server module 136 may configure the teleconference data 146 for the individual client computing devices 106(1)-106(N). Teleconference data can be divided into individual instances referenced as 146(1)-146(N). The output module 140 may communicate the teleconference data instances 146(1)-146(N) to the client computing devices 106(1) through 106(N). Specifically, in this example, the output module 140 communicates teleconference data instance 146(1) to client computing device 106(1), teleconference data instance 146(2) to client computing device 106(2), teleconference data instance 146(3) to client computing device 106(3), and teleconference data instance 146(N) to client computing device 106(N), respectively.

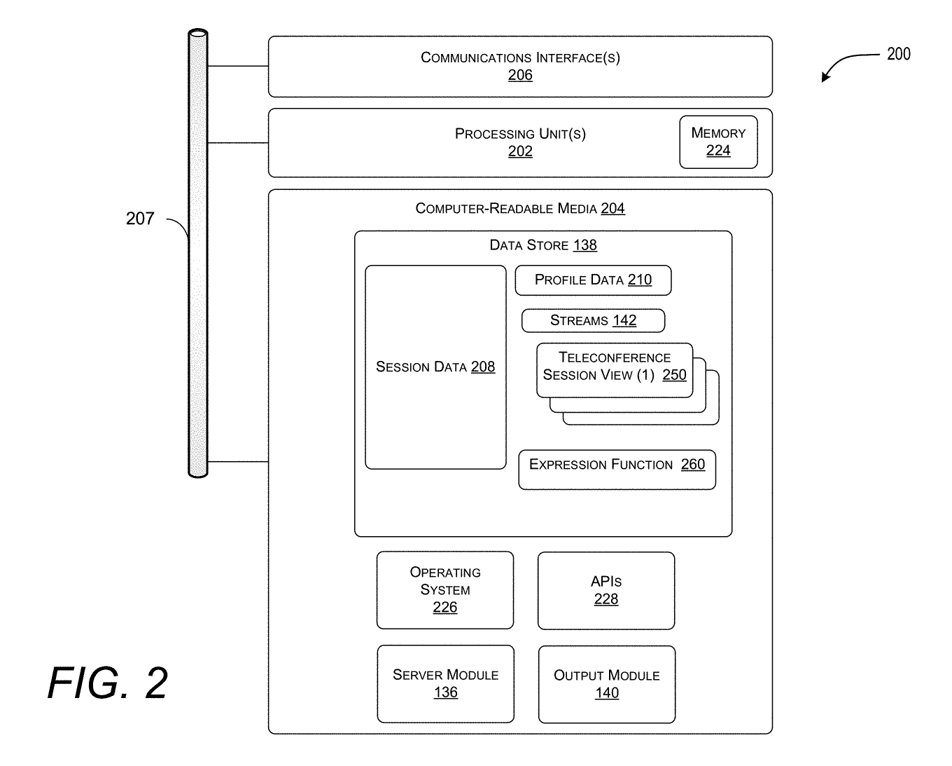

The teleconference data instances 146(1)-146(N) may communicate audio that may include video representative of the contribution of each participant in the teleconference session 104. Each teleconference data instance 146(1)-146(N) may also be configured in a manner that is unique to the needs of each participant user of the client computing devices 106(1) through 106(N). Each client computing device 106(1) through 106(N) may be associated with a teleconference session view. Examples of the use of teleconference session views to control the views for each user at the client computing devices 106 are described with reference to FIG. 2.

In FIG. 2, a system block diagram is shown illustrating components of an example device 200 configured to provide the teleconference session 104 between the client computing devices, such as client computing devices 106(1) through 106(N) in accordance with an example implementation. The device 200 may represent one of device(s) 110 where the device 200 includes one or more processing unit(s) 202, computer-readable media 204, and communication interface(s) 206. The components of the device 200 are operatively connected, for example, via a bus 207, which may include one or more of a system bus, a data bus, an address bus, a PCI bus, a Mini-PCI bus, and any variety of local, peripheral, and/or independent buses.

As utilized herein, processing unit(s), such as the processing unit(s) 202 and/or processing unit(s) 112, may represent, for example, a CPU-type processing unit, a GPU-type processing unit, a field-programmable gate array (“FPGA”), another class of digital signal processor (“DSP”), or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 204 and/or computer-readable media 114, may store instructions executable by the processing unit(s). The computer-readable media may also store instructions executable by external processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random-access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communications media. That is, computer storage media does not include communications media consisting solely of a modulated data signal, a carrier wave, or a propagated signal, per se.

Communication interface(s) 206 may represent, for example, network interface controllers (“NICs”) or other types of transceiver devices to send and receive communications over a network. The communication interfaces 206 are used to facilitate communication over a data network with client computing devices 106.

In the illustrated example, computer-readable media 204 includes the data store 138. In some examples, the data store 138 includes data storage such as a database, data warehouse, or other type of structured or unstructured data storage. In some examples, the data store 138 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 138 may store data for the operations of processes, applications, components, and/or modules stored in computer-readable media 204 and/or executed by processing unit(s) 202 and/or accelerator(s). For instance, in some examples, the data store 138 may store session data 208 (e.g., session data 144), profile data 210, and/or other data. The session data 208 may include a total number of participants in the teleconference session 104, and activity that occurs in the teleconference session 104 (e.g., behavior, activity of the participants), and/or other data related to when and how the teleconference session 104 is conducted or hosted. Examples of profile data 210 include, but are not limited to, a participant identity (“ID”) and other data.

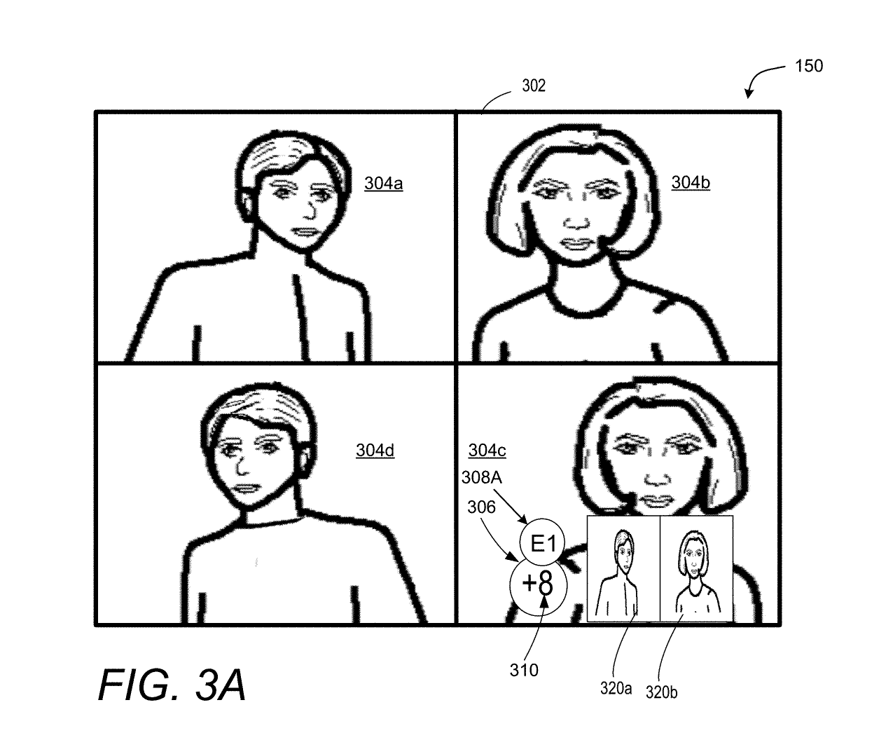

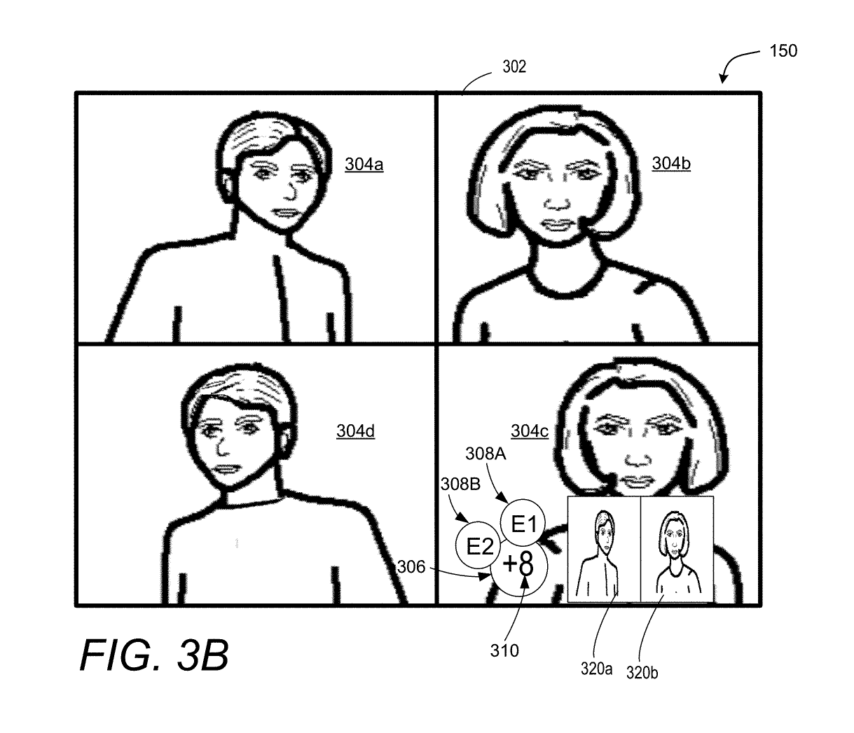

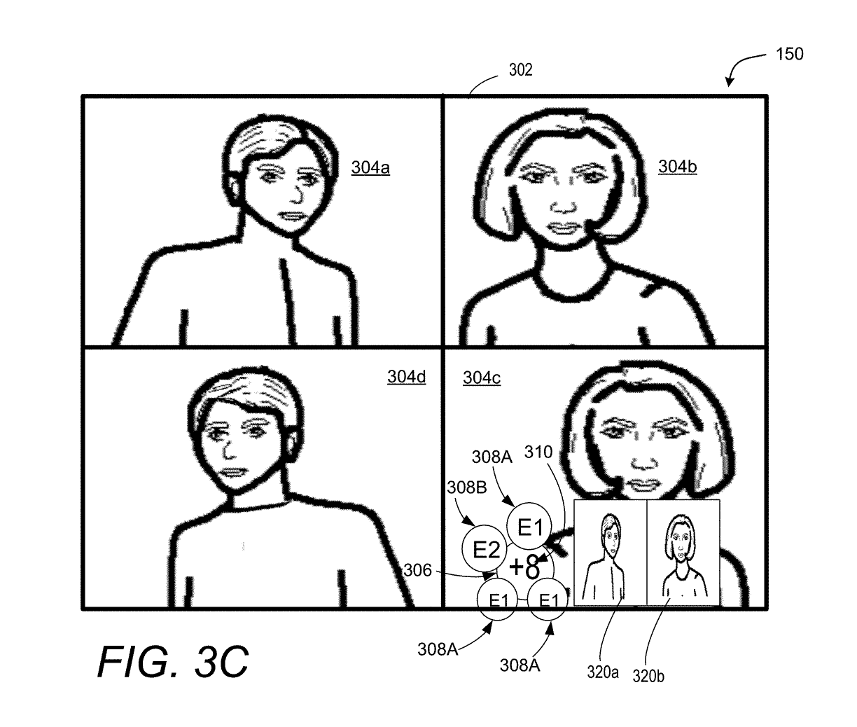

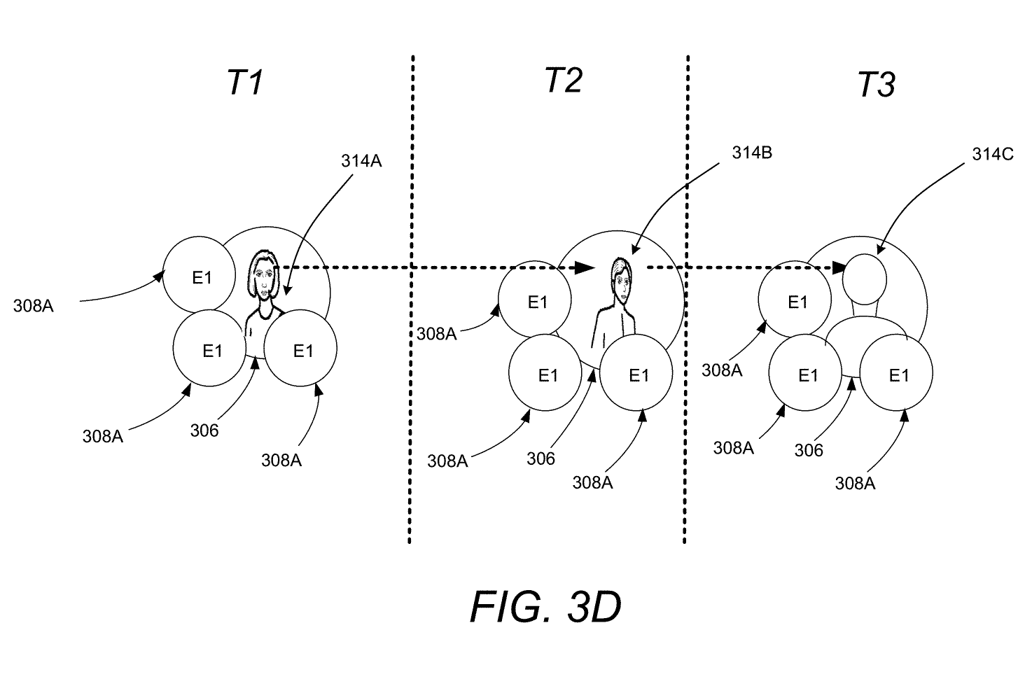

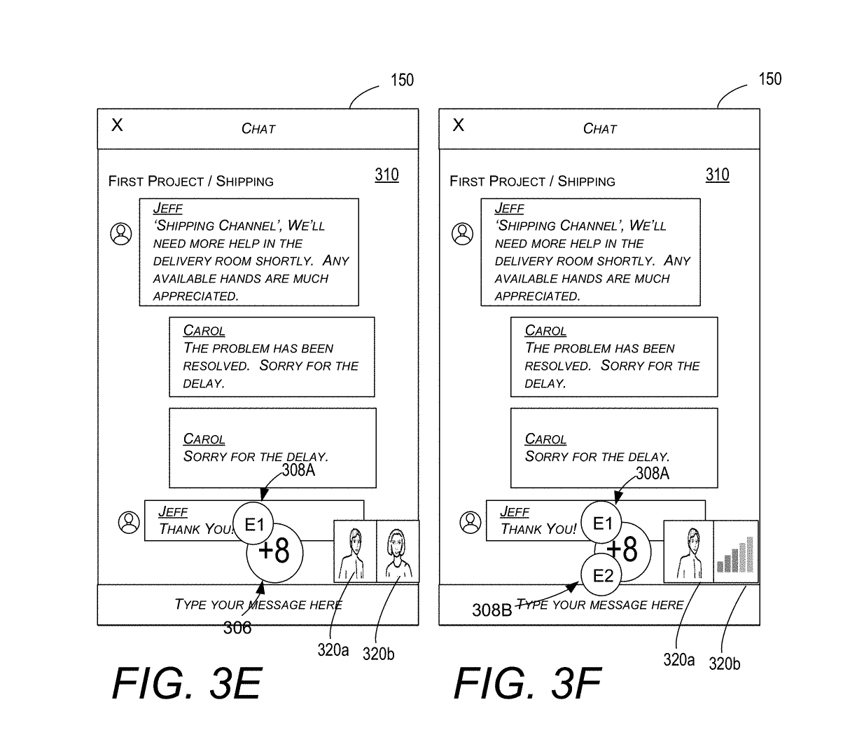

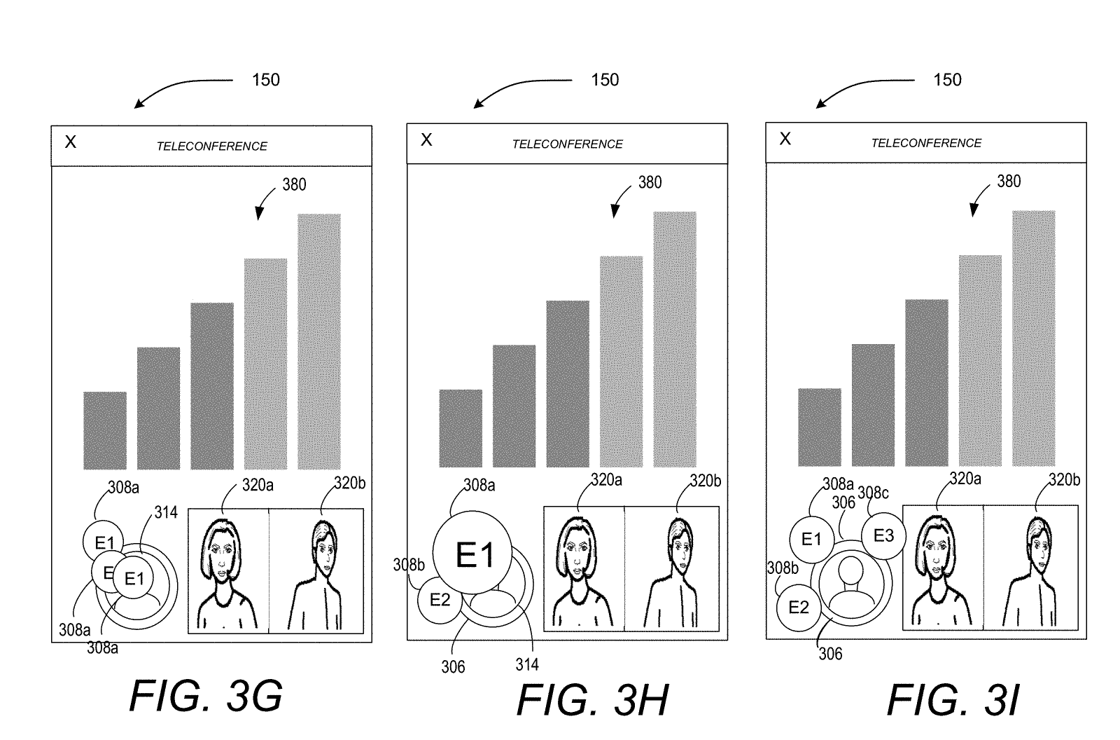

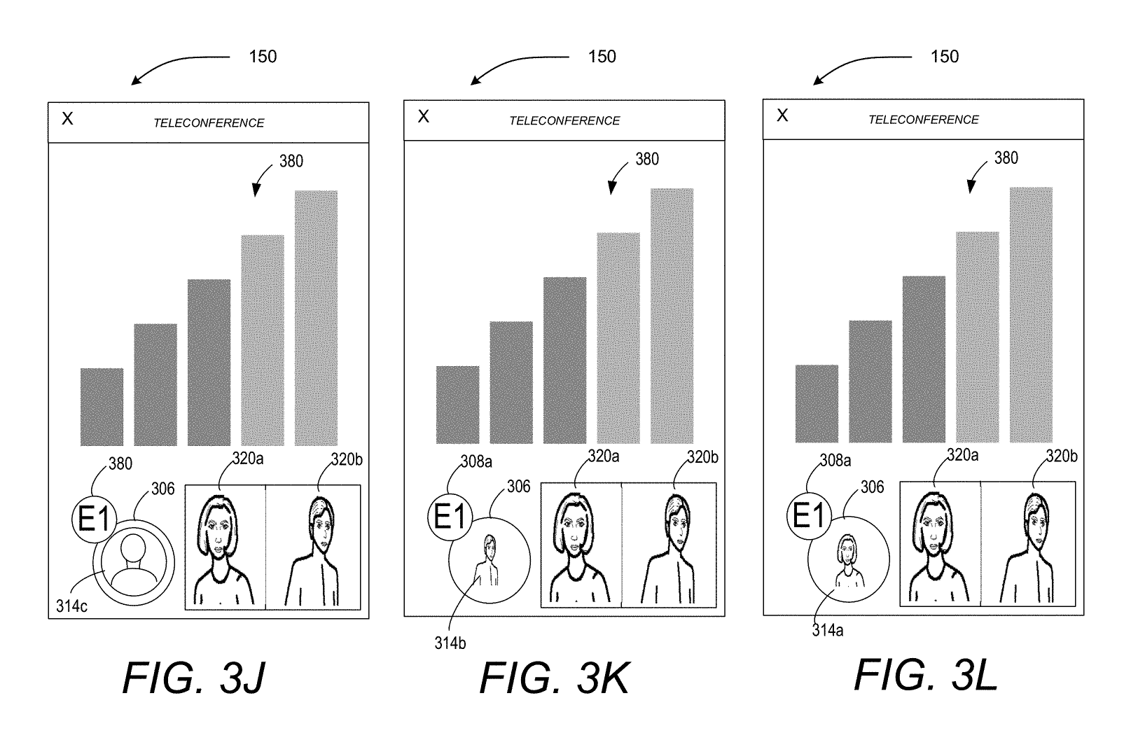

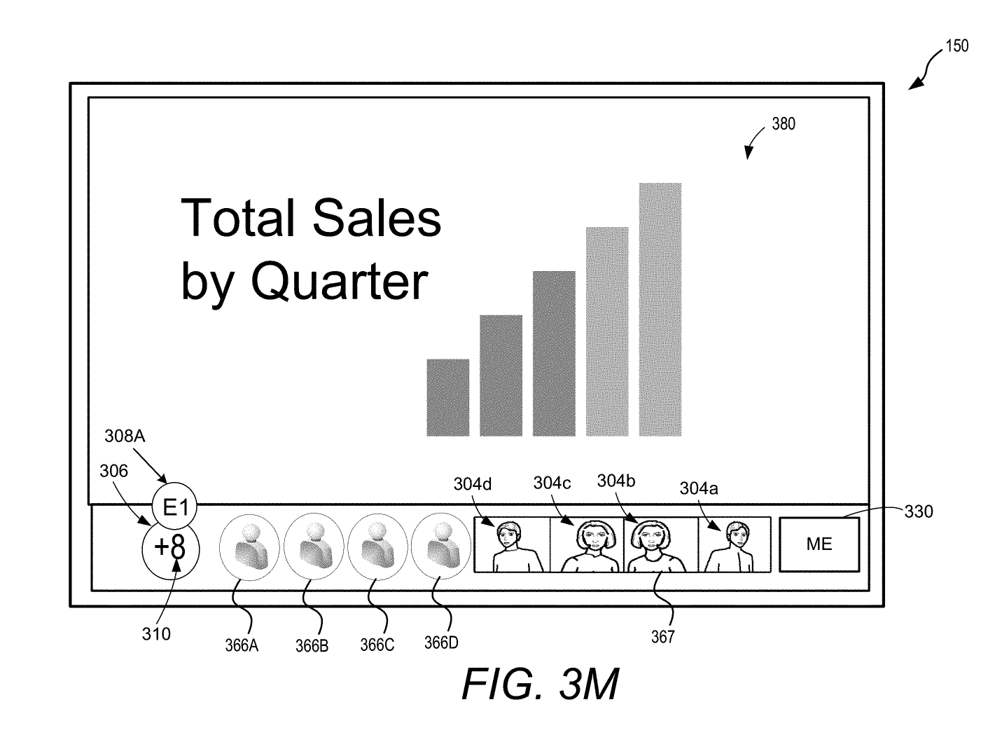

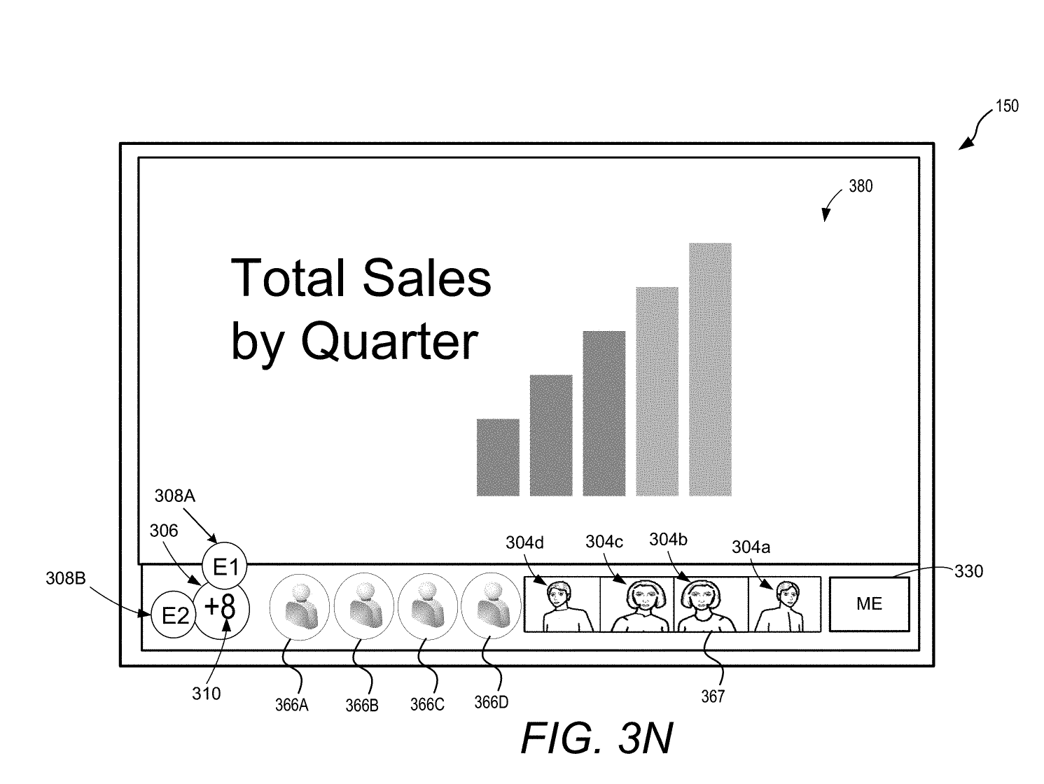

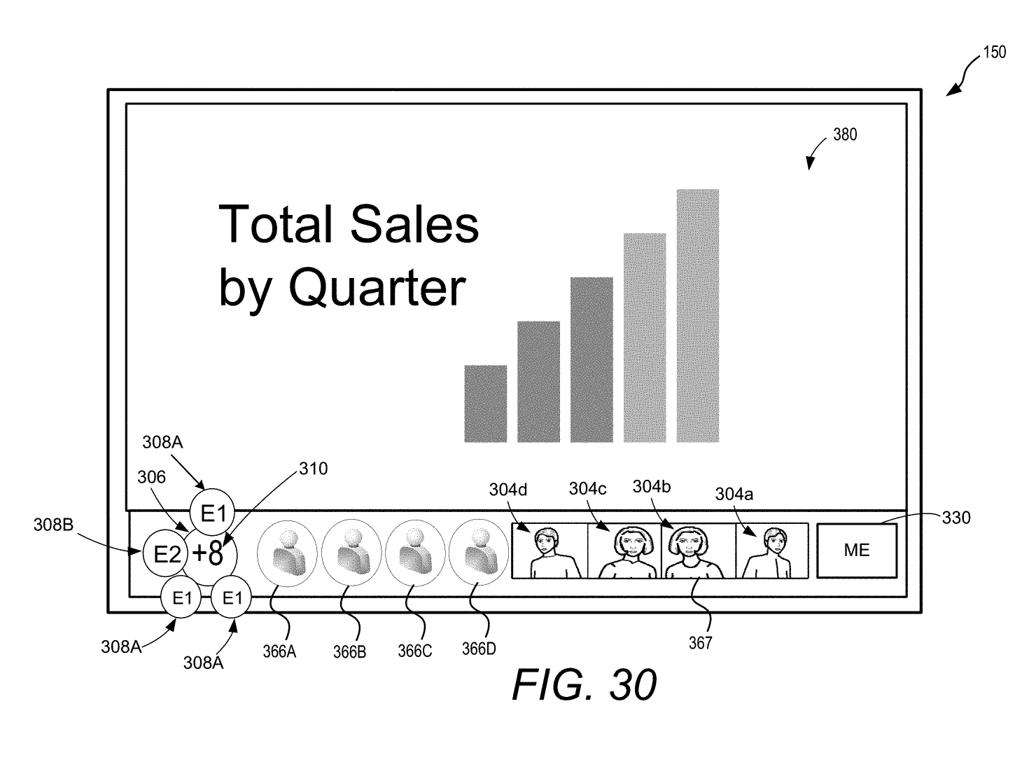

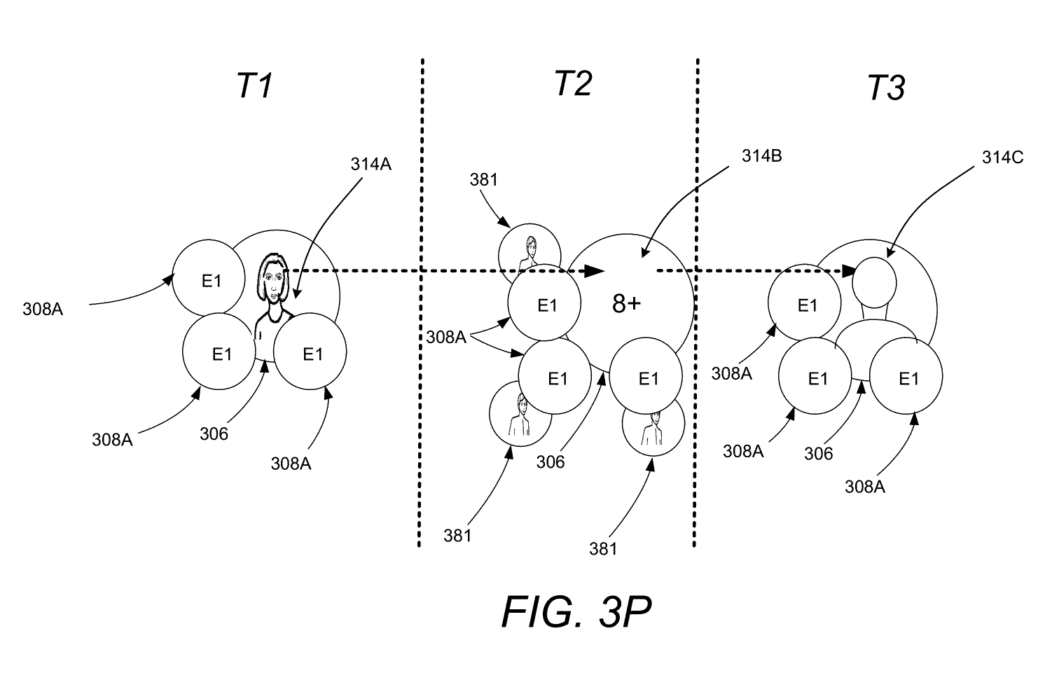

In an example implementation, the data store 138 stores data related to the view each participant experiences on the display of the users' client computing devices 106. As shown in FIG. 2, the data store 138 may include a teleconference session view 250(1) through 250(N) corresponding to the display of each client computing device 106(1) through 106(N) participating in the teleconference session 104. In this manner, the system 102 may support individual control over the view each user experiences during the teleconference session 104. For example, as described in more detail below with reference to FIGS. 3A-3O, the system 102 displays an indication of a group expression in addition to displaying other content associated with the teleconference session. In some examples, the group expression can be displayed as an overlay view. Overlay views feature the display of desired media that cover a portion of a display area. Controls, user interface elements such as icons, buttons, menus, etc., and other elements not directly relevant to the presentation provided by the teleconference session on the display simply do not appear.

The view on a user's display may be changed to keep the user engaged in the teleconference session even though many of the users participating in the teleconference session 104 cannot be seen in the stage view. For example, as the user is viewing active participants and/or content currently being presented, the user can also see how other users (e.g., non-active participants) are reacting during the teleconference session 104. These reactions can be seen via the display of one or more graphical user interface elements representing the group expression. The system 102 can select a size and/or location of a rendering of a group expression associated with the teleconference session that optimizes the display of the content.

The teleconference session view 250(1)-250(N) may store data identifying the view being displayed for each client computing device 106(1)-106(N). The teleconference session view 250 may also store data relating to streams 142 configured for display, the participants associated with the streams, whether content media is part of the display, and information relating to the content. Some teleconference sessions may involve a large number of participants. However, as briefly discussed above only a core number of the users may be what can be referred to as “active users” or “active participants.” The teleconference session view for each user may be configured to focus on media provided by the most active users. Some teleconference sessions may involve a presenter entity, such as in a seminar, or a presentation by one or more individual presenters. At any given time, one user may be a presenter, and the presenter may occupy an enhanced role in a teleconference session. The presenter's role may be enhanced by maintaining a consistent presence on the user's display. Information relating to the presenter may be maintained in the teleconference session view 250.

As noted above, the data store 138 may store the profile data 210, streams 142, teleconference session views 250, session data 208, and expression function 260. Alternately, some or all of the above-referenced data can be stored on separate memories 224 on board one or more processing unit(s) 202 such as a memory on board a CPU-type processor, a GPU-type processor, an FPGA-type accelerator, a DSP-type accelerator, and/or another accelerator. In this example, the computer-readable media 204 also includes an operating system 226 and an application programming interface(s) 228 configured to expose the functionality and the data of the device(s) 110 (e.g., example device 200) to external devices associated with the client computing devices 106(1) through 106(N). Additionally, the computer-readable media 204 includes one or more modules such as the server module 136 and an output module 140, although the number of illustrated modules is just an example, and the number may vary higher or lower. That is, functionality described herein in association with the illustrated modules may be performed by a fewer number of modules or a larger number of modules on one device or spread across multiple devices.

As such and as described earlier, in general, the system 102 is configured to host the teleconference session 104 with the plurality of client computing devices 106(1) through 106(N). The system 102 includes one or more processing units 202 and a computer-readable medium 204 having encoded thereon computer-executable instructions to cause the one or more processing units 202 to receive streams 142(1) through 142(M) at the system 102 from a plurality of client computing devices 106(1) through 106(N), select streams 142 based, at least in part, on the teleconference session view 250 for each user, and communicate teleconference data 146 defining the teleconference session views 250 corresponding to the client computing devices 106(1) through 106(N). The teleconference data instances 146(1) through 146(N) are communicated from the system 102 to the plurality of client computing devices 106(1) through 106(N). The teleconference session views 250(1) through 250(N) cause the plurality of client computing devices 106(1) through 106(N) to display views of the teleconference session 104 under user control. The computer-executable instructions also cause the one or more processing units 202 to determine that the teleconference session 104 is to transition to a different teleconference session view of the teleconference session 104 based on a user communicated control signal 156.

As discussed, the techniques disclosed herein may utilize one or more “views.” In some examples, the views include the stage view (also referred to herein as “teleconference session views”) and possibly other views that include different content and/or less content as compared to the stage view. In an example of an operation, the system 102 performs a method that includes receiving the streams 142(1) through 142(M) at the system 102 from a plurality of client computing devices 106(1) through 106(N). The system combines and formats the streams 142 based, at least in part, on a selected teleconference session view for each client computing device to generate teleconference data 146, e.g., teleconference data instances 146(1) through 146(N). The teleconference data instances 146(1) through 146(N) are then communicated to the individual client computing devices 106(1) through 106(N).

It is noted that the above description of the hosting of a teleconference session 104 by the system 102 implements the control of the teleconference session view in a server function of the device 110. In some implementations, the server function of the device 110 may combine all media portions into the teleconference data 146 for each client computing device 106 to configure the view to display. The information stored in the teleconference session view as described above may also be stored in a data store 138 of the client computing device 106. The client computing device 106 may receive a user input and translate the user input as being a view switching control signal that is not transmitted to the server. The control signal may be processed on the client computing device itself to cause the display to switch to the desired view. The client computing device 106 may change the display by re-organizing the portions of the teleconference data 146 received from the server according to the view selected by the user. The expression function 260 can be configured to determine where to display the teleconference data 146 associated with the indication of the group expression detected by the system 102.

The ability for users participating in a teleconference session 104 to view group expressions as well as other content relating to the teleconference session 104 is described with reference to screenshots of the display. Specifically, reference is made to FIGS. 3A-3O, which illustrate various examples of displays indicating a group expression. In some configurations, an indication of a group expression is not displayed unless the system 102 detects a group expression. The displayed group expression can show content relating to the type of expression indicated by the group of users as well as, in some examples, the users who provided the indication of the expression.

FIG. 3A depicts an example of a display 150, which is shown connected to interface 134 of client computing device 106(1) in FIG. 1, displaying a stage view of the teleconference session 104 in accordance with an example implementation. The stage view can, in some configurations, extend substantially across the screen area 302 of the display 150. In some configurations, the display area 302 is configured in a manner that dominates the display. In some configurations, the display area 302 can be substantially from edge-to-edge of the display 150.

As illustrated, the display area 302 is divided into four graphical elements 304a-304d each corresponding to streams of a teleconference session 104. The streams 142 can include audio, audio and video, or audio and an image communicated from a client computing device 106 belonging to a user participating in the teleconference session 104.

Four graphical elements 304a-304d are shown occupying the display area 302 in the example shown in FIG. 3A; however, any number of graphical elements may be displayed. In some examples, the number of displayed graphical elements may be limited to a specified maximum by available bandwidth or by a desire to limit video clutter on the display 150. Fewer than four graphical elements 304a-304d may be displayed when fewer than four participants are involved in the teleconference session 104. In teleconference sessions involving more than the maximum number of graphical elements, the graphical elements 304a-304d displayed may correspond to the dominant participants or those deemed to be “active participants.” The designation of “active participants” may be defined as a reference to specific presenters, or as in some implementations, a function may be provided to identify “active participants” versus “passive” or “in-active” participants by applying a teleconference session activity level priority. The streams 142 can also include renderings of content and groups of participants. In some configurations, an overflow graphical element 306 is displayed that provides an indication that other users are participating in the teleconference session 104. In the example of FIG. 3A, there are eight additional users participating in the teleconference session as indicated by graphical element 310 displayed within the graphical element 306.

The activity level priority ranks participants based on their likely contribution to the teleconference session 104. In an example implementation, an activity level priority for identifying active versus passive participants may be determined at the server module 136 by analyzing streams 142 associated with individual participants. The teleconference system may include a function that compares the activity of participants and dynamically promotes those who speak more frequently or those that move and/or speak more frequently to be designated the active participants.

The order of the graphical elements 304a-304d may also reflect the activity level priority of the participants to which the graphical elements correspond. For example, a stage view may be defined as having a convention in which the top left corner of the primary display area 302 displays the graphical element 304a corresponding to the most dominant participant. In some sessions, the dominant participant may be a presenter. The top right corner of the primary display area 302 may display the graphical element 304b corresponding to the second ranked participant. The lower right hand corner of the primary display area 302 may display the graphical element 304c corresponding to the third ranked participant. The lower left hand corner of the primary display area 302 may display the graphical element 304d corresponding to the lowest ranked participant. In some sessions, the top right corner may display the graphical element 304a corresponding to a presenter, and the other three positions on the primary display area 302 may dynamically switch to more active participants at various times during the teleconference session 104.

In an example implementation, when an indication of a group expression is detected by the system 102 as described above, a group expression graphical element 308A can be displayed. In the current example, the group expression graphical element 308a indicates that at least some threshold number of users participating in the teleconference session 104 has provided the indication of an expression for expression E1. As described above, a user via a client computing device 106 can select from a plurality of expressions. While “E1” is shown in FIG. 3A, other graphical data can be shown to indicate the expression. For example, an emoji representing the expression can be displayed. Further, as described herein, one or more display characteristics can be changed when providing the indication of the group expression.

FIG. 3B depicts an example of a display 150, which is shown connected to interface 134 of client computing device 106(1) in FIG. 1, displaying two group expressions in a stage view of the teleconference session 104 in accordance with an example implementation. As illustrated, the display area 302 is divided into four graphical elements 304a-304d each corresponding to streams of a teleconference session 104. The streams 142 can include audio, audio and video, or audio and an image communicated from a client computing device belonging to a user participating in the teleconference session 104.

In the current example, the system 102 has detected both a first group expression “E1” and a second group expression “E2”. For example, the system 102 can detect that a group of users has provided an indication of an expression associated with selection of a “clapping” emoji and detect an indication of an expression associated with the selection of a “thumbs up” emoji. In response to detecting the first group expression and the second group expression, the system 102 causes the display of the graphical element 308A associated with the first expression “E1” and the display of the second graphical element 308B associated with the second expression “E2”.

FIG. 3C depicts an example of a display 150, which is shown connected to interface 134 of client computing device 106(1) in FIG. 1, displaying an indication of an expression received from a group of users participating in a teleconference session 104 in accordance with an example implementation. As illustrated, the display area 302 is divided into four graphical elements 304a-304d, each corresponding to streams 142 of a teleconference session 104. The streams 142 can include audio, audio and video, or audio and an image communicated from a client computing device 106 belonging to a user participating in the teleconference session 104.

In the current example, the system 102 has detected a number of users participating in the teleconference session 104 that have provided an indication of an expression “E1”. As illustrated, instead of displaying a single graphical element 308A representing the group expression for “E1,” the system 102 has generated multiple graphical elements 308A showing “E1.” In some configurations, as more and more users provide the same indication of an expression, the system 102 adds the display of graphical elements representing the indication of the expression to the display area. When the system 102 detects fewer users providing the indication of the expression, the system 102 causes fewer graphical elements 308A to be displayed. For example, when there are no longer any users providing an indication of the expression, the system 102 will cause the graphical elements 308A to be removed. The system can also change one or more display characteristics associated with a graphical element 308A. In the current example, the system 102 has adjusted a size of the graphical element 308A.

FIG. 3D depicts an example of a display 150, which can be connected to the interface 134 of the client computing device 106(1) in FIG. 1, displaying an indication of an expression received from a group of three users participating in a teleconference session 104 in accordance with an example implementation.

In the current example, the system 102 has detected three users participating in the teleconference session 104 that have provided an indication of an expression “E1.” As illustrated, in addition to displaying graphical elements 308A representing the expression for “E1,” the system 102 has generated teleconference data 146 that includes a graphical representation of each of the users participating in the teleconference session that have provided the indication of the expression “E1.” At time T1, the graphical element 306 includes a representation of a user 314A who provided the indication of the expression “E1.” At time T2, the graphical element 306 includes a representation of a user 314B who provided the indication of the expression “E1.” At time T3, the graphical element 306 includes a representation of a user 314C who provided the indication of the expression “E1”. At time T3, an avatar representation has been displayed within graphical element 306. In some examples, video, or camera data may not be available to show an actual representation of a user. As discussed above, in some examples, when the group of users providing an indication of an expression is below some threshold number, the system 102 can provide identifying data as to the users who have provided the indication of the expression.

FIG. 3E depicts an example of a display 150, which is shown connected to interface 134 of client computing device 106(1) in FIG. 1, displaying an indication of an expression received from a group of users participating in a teleconference session 104 in accordance with an example implementation. As illustrated, the display 150 is displaying a different view from the stage view as illustrated in FIGS. 3A-3D. In this example, the stage view has transitioned to a view 310 that is associated with “chat” functionality. The view 310 also comprises a teleconference monitor views 320a and 320b. Teleconference monitor view 320a renders a first stream of a teleconference session 104, e.g., content relating to an active presenter. Teleconference monitor view 320b renders a second stream of a teleconference session 104, e.g., content relating to the user associated with the display 150. In some configurations, a teleconference monitor view 320b can be a “ME” display. The ME display of the teleconference monitor view 320b includes an image, an avatar, or a video of the user and/or camera view of the client computing device 106(1) on which the teleconference session 104 is playing. The ME display may be displayed as a miniaturized video or image screen having any suitable aspect ratio such as for example, 16:9, 4:3, 3:2, 5:4, 5:3, 8:5, 1.85:1, 2.35:1, or any aspect ratio deemed suitable in specific implementations. The ME display may include a pin (not shown) to pin the ME display to the teleconference monitor view 320b. Any or all of the user interface elements described herein, such as the ME display may also include a pin to pin the corresponding user interface element to the display. In addition to displaying the “ME” content within the teleconference monitor view 320b, the active presenter within the teleconference monitor view 320a, the display 150 also includes the display area 306 for displaying content associated with non-active users participating in the teleconference session 104.

Similar to the display illustrated in FIG. 3A, when an indication of a group expression is detected by the system 102 as described above, a group expression graphical element 308A can be displayed. In the current example, the group expression graphical element 308a indicates that at least some threshold number of users participating in the teleconference session has provided the indication of an expression for expression E1. As described above, a user, via a client computing device 106 can select from a plurality of expressions.

FIG. 3F depicts a transition of the view 310 to include depiction of a second group expression detected by the system 102, in accordance with examples presented herein. In the current example, a second group expression is depicted using graphical element 308B. FIG. 3F also shows the replacement of the content of the teleconference monitor view 320b with a display of content currently being presented.

FIGS. 3G, 3H, and 3I depict a view 380 associated with a user interacting with a chart while viewing content associated with the teleconference session 104. FIG. 3G illustrates the system 102 providing multiple graphical elements 308a to represent a group expression “E1” along with a graphical representation of the users who provided the indication of the expression “E1.” FIG. 3H illustrates the system 102 providing a graphical element 308a to represent the group expression “E1,” a graphical element 308b to represent a second indication of expression “E2,” along with a graphical representation of the users who provided the indication of the expression for “E1” and/or “E2.” FIG. 3I illustrates the system 102 providing a graphical element 308a to represent the group expression “E1,” a graphical element 308b to represent a second indication of expression “E2,” and a graphical element 308c to represent a second indication of expression “E3.”

FIGS. 3J, 3K, and 3L depict a view 380 associated with a user interacting with a chart while viewing content associated with the teleconference session 104. In the current example, the system 102 has detected a group expression for the expression “E1.” The system 102 has displayed a graphical picture representation of at least a portion of the users that provided the indication of the expression E1 within the graphic element 306. FIG. 3J shows an avatar representation of a user 314c. FIG. 3K shows a picture or video of a user 314b. FIG. 3L shows a picture or video of a user 314a. According to some configurations, the system 102 changes the graphical representation of the user within graphical element 306 according to a cycle time (e.g., 0.2 seconds, 0.3 seconds, 1 second, . . . ).

Generally, the position and/or size of a user interface element or a graphical user interface associated with, e.g., containing, the teleconference monitor view or the group expression can be changed. In some examples, the position and/or size are based on user preferences. In other examples, the position and/or size is based on the content currently being displayed. For instance, in the current example depicted in FIG. 3J, the system 102, or some other component, can analyze the display 150 to determine a location and size for a graphical element associated with the display of the group expression. According to some configurations, the system 102 identifies locations of the display that do not include selectable user interface elements such that the display of the group expression is not placed over a portion of the display 150 with which the user may desire to interact.

FIGS. 3M, 3N, and 3O depict passive elements displayed with a view 380 associated with a user interacting with a chart while viewing content associated with the teleconference session 104. In some configurations, the display 150 includes a rendering of passive elements, such as passive elements 366A-366D, which are individually and generically referred to herein as “passive elements 366.” Individual passive elements 366 can represent participants of the teleconference session 104. In comparison to active elements, which can include video streams 142 of active participants, the passive elements 366 represent participants that have an activity level below a threshold. In some examples, the participants represented by the passive elements 366 can be referred to as non-active participants.

In some configurations, when the activity level of a participant represented as a passive element 366 increases above the threshold, that participant can be moved from a passive element 366 to an active element displayed as a video stream 142. In some configurations, when the activity level of a participant represented as a passive element 366 increases above an activity level of a participant represented as an active element, that participant can be moved from a passive element 366 to an active element displayed as a video stream 142.

FIGS. 3M, 3N, and 3O also illustrate the display of active participants, as illustrated by elements 304a-304d, within graphical display area 367. The display area 367 is also referred to herein as a box of multiple display streams. In this view, the user can not only view the content being presented, but can also view the currently active participants of the teleconference session 104. The display area 367 also shows the ME view within graphical element 330. As discussed above, the ME display includes an image, an avatar, or a video of the user and/or camera view of the client computing device 106(1) on which the teleconference session is playing.

FIGS. 3M, 3N, and 3O also illustrate an overflow graphical element 306 that provides an indication of how many other users are participating in the teleconference session 104. In the example of FIGS. 3M, 3N, and 3O, there are eight additional users participating in the teleconference session 104 as indicated by graphical element 310 displayed within the graphical element 306.

In the example illustrated by FIG. 3M, the system 102 has detected a number of users participating in the teleconference session 104 have provided an indication of an expression “E1.” As illustrated, a single graphical element 308A representing the group expression for “E1” is displayed.

Moving to FIG. 3N, the system 102 has detected a number of users participating in the teleconference session 104 have provided an indication of an expression “E1” and an indication of an expression “E2.” As illustrated, a single graphical element 308A representing the group expression for “E1” is displayed along with a display of a single graphical element 308B representing the group expression for “E2.”

As illustrated by FIG. 3O, the system 102 has detected that a number of users, under a threshold value, participating in the teleconference session 104 have provided an indication of an expression “E1” and a number of users above the threshold value have provided an indication of an expression “E2.” The system 102 determines the number of indications of expressions received for the “E1” indication of expression and the “E2” indication of expression. As illustrated, the system 102 causes a display of a plurality of graphical elements 308A representing the group expression for “E1” based on the number of indications of expression received for “E1.” In the current example, the system 102 determines that the number of indications of expression “E1” is lower than a threshold. In some configurations, the threshold is based on a number of graphical elements that can be displayed proximately (e.g., touching, nearly touching) to the overflow element 306. For example, for a mobile device with a small display, the threshold could be 4, 6, or 8, whereas for a desktop device with a larger display and larger graphical elements, the threshold could be 8, 10, 12, and the like. Generally, the threshold is set such that the display of the graphical elements associated with the indications of expressions do not result in a “cluttered” display. In other words, a user can still view each of the displayed indications of expression.

Returning to the FIG. 3O, when the system 102 determines that the number of indications for an expression (e.g., “E1”) is lower than the threshold, the system 102 causes a display of a number of graphical elements (308A) indicating indications of expressions received for that expression. When the system 102 determines that the number of indications is not lower than the threshold (e.g., greater than eight), the system causes the display of a single graphical element (308B). As discussed above, in addition to or alternatively, one or more display characteristics can be changed with regard to one or more of the graphical elements 308. For example, an animation rate associated with an animation effect (e.g., clapping) can be adjusted based on the number of users providing the indication of the clapping expression. According to this example, the more users providing the indication, the faster the animation effect, and the fewer users providing the indication, the slower the animation effect.

FIG. 3P depicts an example of a display 150, which can be connected to the interface 134 of the client computing device 106(1) in FIG. 1, displaying an indication of an expression received from a group of three users participating in a teleconference session 104 in accordance with an example implementation.

In the current example, the system 102 has detected three users participating in the teleconference session 104 that have provided an indication of an expression “E1”. As illustrated, in addition to displaying graphical elements 308A representing the expression for “E1,” the system 102 has generated teleconference data 146 that includes a graphical representation of each of the users participating in the teleconference session that have provided the indication of the expression “E1.” At time T1, the graphical element 306 includes a representation of a user 314A who provided the indication of the expression “E1.” At time T2, the graphical element 306 includes a representation of a user 314B who provided the indication of the expression “E1.” At time T3, the graphical element 306 includes a representation of a user 314C who provided the indication of the expression “E1”. At time T3, an avatar representation has been displayed within graphical element 306. In some examples, video, or camera data may not be available to show an actual representation of a user. As discussed above, in some examples, when the group of users providing an indication of an expression is below some threshold number, the system 102 can provide identifying data as to the users who have provided the indication of the expression. Also shown in FIG. 3P, user graphical elements 381 representing or displaying users associated with the group expression graphical elements 308 are displayed. As shown, the user graphical elements 381 can be visually connected to the associated group expression graphical element 308. The visual connection can be made by having the elements touch one another, overlap one another, or have any other graphical element indicating a connection between the two elements (381 and 308).

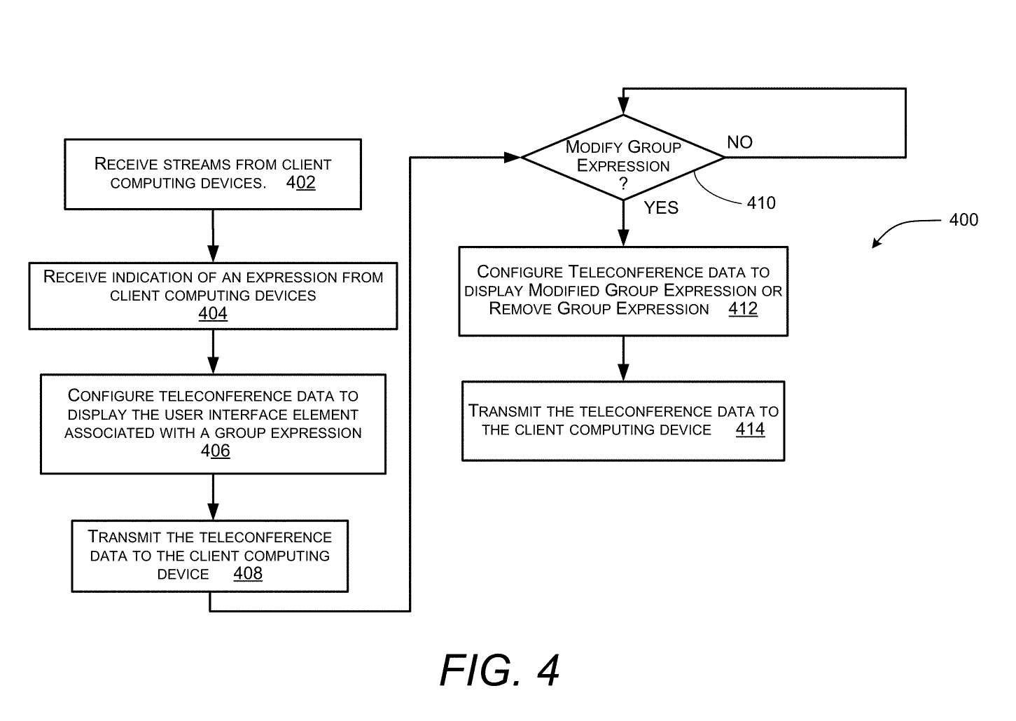

Turning now to FIG. 4, aspects of a routine 400 for presenting a group expression on the display of a client computing device 106 are shown and described. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof.

For example, the operations of the routine 400 are described herein as being implemented, at least in part, by an application, component and/or circuit, such as the server module 136 in device 110 in FIG. 1 in the system 100 hosting the teleconference session 104. In some configurations, the server module 136 can be a dynamically linked library (DLL), a statically linked library, functionality produced by an application programming interface (API), a compiled program, an interpreted program, a script or any other executable set of instructions. Data and/or modules, such as the server module 136, can be stored in a data structure in one or more memory components. Data can be retrieved from the data structure by addressing links or references to the data structure.

Although the following illustration refers to the components of FIG. 1 and FIG. 2, it can be appreciated that the operations of the routine 400 may also be implemented in many other ways. For example, the routine 400 may be implemented, at least in part, or in modified form, by a processor of another remote computer or a local circuit, such as for example, the client module 130 in the client computing device 106(1). In addition, one or more of the operations of the routine 400 may alternatively or additionally be implemented, at least in part, by a chipset working alone or in conjunction with other software modules. Any service, circuit or application suitable for providing the techniques disclosed herein can be used in operations described herein.

Referring to FIG. 4, the routine 400 begins at 402, where the server module 136 receives one or more streams, such as a plurality of streams 142(1)-142(M) from corresponding client computing devices 106(1)-106(N). Users of each client computing device communicate a request to join the teleconference session 104 and for the server to communicate a media stream 142 once authorized to participate in the teleconference session 104. The server module 136 receives the streams 142 from each client computing device 106.

At step 404, the server module 136 receives the indication of an expression from a plurality of client computing devices 106. As discussed above, the server module 136 can receive an indication of an expression from a group of users near in time to each other. For instance, a group of users may provide an indication of a “thumbs up” expression in response to some activity that occurred during the teleconference session 104. In some configurations, the server module 136 determines a number of users that provided the indication of expression within some predetermined time period. For instance, if a threshold number of users provide the same indication of expression within some predetermined time period (e.g., 10 seconds or some other period of time), the server module 136 identifies that a group expression occurred.

At step 406, the teleconference data 146 corresponding to a selected client computing device 106(1) having a display device 150 is configured to display the user interface element associated with the detected group expression. In some configurations, step 406 can involve an operation to determine the display characteristics to associate with the group expression. For instance, the server can determine to provide an animation effect in addition to displaying content indicating the users that provided the indication of the expression. In some configurations, the group expression graphical element can include content from one or more of the streams 142(1)-142(M). For instance, the group expression graphical element can include content associated with each user that provided the indication of the expression.

In configuring the group expression graphical element, streams 142 of the teleconference data 146 may be arranged in a view based on an activity level priority for streams associated with individual participant presenters. The video or shared content in the streams 142 may be analyzed to determine an activity level priority for any stream of the teleconference data. The activity level priority, which is also referred to herein as a “priority value,” can be based on any type of activity including, but not limited to, any of the following:
1. user motion—the extent to which a user moves in the video may determine the user's activity level. Users in the process of gesturing or otherwise moving in the video may be deemed to be participating at a relatively high level in the teleconference. In some examples, the user motion can be used to identify an indication of an expression (e.g., clapping, thumbs up, thumbs down, first pumping).
2. user lip motion—the video may be analyzed to determine the extent to which a user's lips move as an indication of the extent to which the user is speaking. Users speaking at a relatively high level may be deemed to be participating at a corresponding relatively high level. In some examples, the user lip motion can be used to identify an indication of an expression (e.g., lip reading to identify an expression).
3. user facial expressions—the user's video may be analyzed to determine changes in facial expressions, or to determine specific facial expressions using pattern recognition. Users reacting through facial expressions in the teleconference may be deemed to be participating at a relatively high level. In some examples, the facial expressions can be used to identify an indication of an expression (e.g., smiling, frowning, shock).
4. content modification—video of content being shared in the teleconference may be analyzed to determine if it is being modified. The user interface element corresponding to content may be promoted in rank within the secondary display area or automatically promoted to the primary display area if the video indicates the content is being modified.
5. content page turning—video of content being shared may be analyzed to determine if there is page turning of a document, for example, and assigned a corresponding activity level priority.
6. number of user presenters having content in the primary display area—video of content being shared may be assigned an activity level priority based on the number of users that have a view of the content in the primary display area or secondary display area.
7. user entering teleconference session—streams from users entering a teleconference session may be assigned a high activity level priority. A priority value can be based on the order in which a user joins a session.
8. user leaving teleconference session—streams from users leaving a teleconference session may be assigned a low activity level priority.

At step 408, the teleconference data 146 is transmitted to the selected client computing device 106(1) for display. Once displayed, the user may participate in the teleconference session 104 in the view formatted according to the teleconference session view.

At decision block 410, the client computing device 106(1) provides an indication to the teleconference system 102 whether to modify the group expression. In some configurations, the indication to modify the group expression can be based on whether or not the teleconference system 102 continues to receive the indication of the expression from users participating in the teleconference session 104. In some configurations, the determination to modify the group expression can be based on a number of users providing the indication of expression. As discussed above, the display characteristics of the group expression can change as the number of users providing the indication of the expression increases or decreases.

At step 412, a teleconference stream is generated to display the group expression or remove the group expression. For instance, the group expression can be similar to the displays presented in FIGS. 3A-3O. At step 414, the teleconference stream is transmitted to the client computing device 106 for display. As also discussed above, the server module 136, or some other component, can determine the location at which to position the group expression graphical element.

Although the techniques described herein have been described in language specific to structural features and/or methodological acts, it is to be understood that the appended claims are not necessarily limited to the features or acts described. Rather, the features and acts are described as example implementations of such techniques.

The operations of the example processes are illustrated in individual blocks and summarized with reference to those blocks. The processes are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as FPGAs, DSPs, or other types of accelerators.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, are understood within the context presented that certain examples include, while other examples do not include, certain features, elements and/or steps. Thus, such conditional language is not generally intended to imply that certain features, elements and/or steps are in any way required for one or more examples, or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

The present disclosure includes the following examples.

### Example 1

A method comprising: receiving one or more streams associated with a teleconference session; causing a display of a graphical user interface on a client computing device associated with a user participating in the teleconference session, wherein the graphical user interface includes a rendering of at least one of the one or more streams and an overflow graphical element representing a group of users participating in the teleconference session; receiving a number of indications of an expression from computing devices associated with at least a portion of the group of users; when the number of indications is lower than a threshold, causing a display of graphical elements indicating the expression, wherein a number of the displayed graphical elements corresponds to the number of indications; and when the number of indications is not lower than the threshold, causing the display of a graphical element indicating the expression, wherein one or more display characteristics associated with the graphical element change based, at least in part, on the number of indications received for the expression.

### Example 2

The method of example 1, wherein the display of individual ones of the graphical elements are in proximity to the overflow graphical element.

### Example 3

The method of examples 1 and 2, wherein the one or more display characteristics includes one or more of an animation effect of the expression, and wherein a rate of the animation effect changes based on the number of indications received.

### Example 4

The method of examples 1 through 3, further comprising displaying, within the overflow graphical element, first graphical data of a first user associated with a first one of the computing devices for a first period of time and displaying, within the overflow graphical element, second graphical data of a second user associated with a second one of the computing devices for a second period of time.

### Example 5

The method of examples 1 through 4, further comprising changing one or more of a size of the graphical element or a color of the graphical element based, at least in part, on the number of indications received.

### Example 6

The method of examples 1 through 5, further comprising removing the display of one or more of the graphical elements based at least partly in response to determining that the indication of the expression is not received for a period of time.

### Example 7

The method of examples 1 through 6, wherein causing the display of the graphical elements comprises overlaying the graphical elements, at least partially, on the overflow graphical element.

### Example 8

The method of examples 1 through 7, further comprising receiving an indication of a second expression from a number of the computing devices; and causing a display, on one or more display devices associated with one or more of the computing devices, of a second graphical element indicating a group expression of the second expression.

### Example 9

A system, comprising: one or more processing units; and a computer-readable medium having encoded thereon computer-executable instructions to cause the one or more processing units to: cause a first stream of teleconference data for a teleconference session to be rendered within a first graphical user interface on a display; receive, from a client computing device associated with a user of the teleconference session, an indication of a first expression; identify a group expression for the indication of the expression based at least in part on a determination that the indication of the first expression is received from other computing devices associated with other users of the teleconference session; generate teleconference data that includes data associated with a display of a group expression graphical element that indicates that the indication of the first expression was received from a group of users participating in the teleconference session; and cause a display, on a display device associated with the client computing device, of the group expression graphical element.

### Example 10

The system of example 9, where causing the display of the teleconference data indicating the group expression of the first expression comprises changing a display characteristic of the group expression graphical element based, at least in part, on a number of the indication of the first expressions received.

### Example 11

The system of examples 9 through 10, wherein changing the display characteristic includes changing one or more of an animation effect, a size, or a display color associated with the group expression graphical element.

### Example 12

The system of examples 9 through 11, wherein causing the display of the group expression graphical element includes displaying first graphical data associated with a first user for a first period of time and displaying second graphical data associated with a second user for a second period of time.

### Example 13

The system of examples 9 through 12, where the computer-readable medium includes encoded computer-executable instructions to cause the one or more processing units to determine that a number of computing devices from which the indication of the first expression is received exceeds a threshold and in response, cause a display of a second group expression graphical element that indicates the first expression, and wherein the first graphical user interface element displays graphical data associated with one or more of the users associated with the computing devices.

### Example 14

The system of examples 9 through 13, where the computer-readable medium includes encoded computer-executable instructions to cause the one or more processing units to remove the display of the group expression graphical element at least partly in response to determining that a number of computing devices from which the indication of the first expression is received is below a first threshold.

### Example 15

The system of examples 9 through 14, wherein causing the display of the group expression graphical element comprises overlaying the group expression graphical element, at least partially, on an overflow graphical element that indicates a number of non-active users of the teleconference session.

### Example 16

The system of examples 9 through 15, where the computer-readable medium includes encoded computer-executable instructions to cause the one or more processing units to receive an indication of a second expression from one or more of the computing devices; determine that the indication of the second expression is received from at least a number of the computing devices that exceeds a first threshold; and causing a display, on one or more display devices associated with one or more of the computing devices, of a second group expression graphical element indicating a group expression of the second expression.

### Example 17

A method, comprising: receiving, from a number of client computing devices associated with users of the teleconference session, an indication of a first expression; identifying a group expression for the indication of the first expression based on at least in part on the number of client computing devices; generating teleconference data that includes data associated with display of a group expression graphical element, wherein the group expression graphical element indicates that the indication of the first expression was received from a group of users participating in the teleconference session; and causing a display, on one or more display devices associated with one or more of the client computing devices, of the teleconference data including the group expression graphical element.

### Example 18

The method of example 17, where causing the display of the teleconference data comprises changing a display characteristic of the group expression graphical element based, at least in part, on the number of the computing devices.

### Example 19

The method of examples 17 through 18, wherein changing the display characteristic includes changing one or more of an animation effect, a size, or a display color associated with the group expression graphical element.

### Example 20

The method of examples 17 through 19, wherein causing the display of the teleconference data includes displaying first graphical data associated with a first user for a first period of time and displaying second graphical data associated with a second user for a second period of time.

We claim:

1. A method comprising:
receiving one or more streams associated with a teleconference session;
causing a display of a graphical user interface on a client computing device associated with a user participating in the teleconference session, wherein the graphical user interface includes a rendering of at least one of the one or more streams and an overflow graphical element representing a group of users participating in the teleconference session;
receiving a number of indications of an expression from computing devices associated with at least a portion of the group of users;
when the number of indications is lower than a threshold, causing a display of graphical elements indicating the expression, wherein a number of the displayed graphical elements corresponds to the number of indications; and
when the number of indications is not lower than the threshold, causing the display of a graphical element indicating the expression, wherein one or more display characteristics associated with the graphical element change based, at least in part, on the number of indications received for the expression.

2. The method of claim 1, wherein the display of individual ones of the graphical elements are in proximity to the overflow graphical element.

3. The method of claim 2, wherein the one or more display characteristics includes one or more of an animation effect of the expression, and wherein a rate of the animation effect changes based on the number of indications received.

4. The method of claim 1, further comprising displaying, within the overflow graphical element, first graphical data of a first user associated with a first one of the computing devices for a first period of time and displaying, within the overflow graphical element, second graphical data of a second user associated with a second one of the computing devices for a second period of time.

5. The method of claim 1, further comprising changing one or more of a size of the graphical element or a color of the graphical element based, at least in part, on the number of indications received.

6. The method of claim 1, further comprising removing the display of one or more of the graphical elements based at least partly in response to determining that the indication of the expression is not received for a period of time.

7. The method of claim 1, wherein causing the display of the graphical elements comprises overlaying the graphical elements, at least partially, on the overflow graphical element.

8. The method of claim 1, further comprising receiving an indication of a second expression from a number of the computing devices; and causing a display, on one or more display devices associated with one or more of the computing devices, of a second graphical element indicating a group expression of the second expression.

9. A system, comprising:
one or more processing units; and
a computer-readable medium having encoded thereon computer-executable instructions to cause the one or more processing units to:
cause a first stream of teleconference data for a teleconference session to be rendered within a first graphical user interface on a display;
receive, from a client computing device associated with a user of the teleconference session, an indication of a first expression;
identify a group expression for the indication of the expression based at least in part on a determination that the indication of the first expression is received from other computing devices associated with other users of the teleconference session;
generate teleconference data that includes data associated with a display of a group expression graphical element that indicates that the indication of the first expression was received from a group of users participating in the teleconference session; and
cause a display, on a display device associated with the client computing device, of the group expression graphical element.

10. The system of claim 9, where causing the display of the teleconference data indicating the group expression of the first expression comprises changing a display characteristic of the group expression graphical element based, at least in part, on a number of the indication of the first expressions received.

11. The system of claim 10, wherein changing the display characteristic includes changing one or more of an animation effect, a size, or a display color associated with the group expression graphical element.

12. The system of claim 9, wherein causing the display of the group expression graphical element includes displaying first graphical data associated with a first user for a first period of time and displaying second graphical data associated with a second user for a second period of time.

13. The system of claim 9, where the computer-readable medium includes encoded computer-executable instructions to cause the one or more processing units to determine that a number of computing devices from which the indication of the first expression is received exceeds a threshold and in response, cause a display of a second group expression graphical element that indicates the first expression, and wherein the first graphical user interface element displays graphical data associated with one or more of the users associated with the computing devices.

14. The system of claim 9, where the computer-readable medium includes encoded computer-executable instructions to cause the one or more processing units to remove the display of the group expression graphical element at least partly in response to determining that a number of computing devices from which the indication of the first expression is received is below a first threshold.

15. The system of claim 9, wherein causing the display of the group expression graphical element comprises overlaying the group expression graphical element, at least partially, on an overflow graphical element that indicates a number of non-active users of the teleconference session.

16. The system of claim 9, where the computer-readable medium includes encoded computer-executable instructions to cause the one or more processing units to receive an indication of a second expression from one or more of the computing devices; determine that the indication of the second expression is received from at least a number of the computing devices that exceeds a first threshold; and causing a display, on one or more display devices associated with one or more of the computing devices, of a second group expression graphical element indicating a group expression of the second expression.

17. A method, comprising:
receiving, from a number of client computing devices associated with users of the teleconference session, an indication of a first expression;
identifying a group expression for the indication of the first expression based on at least in part on the number of client computing devices;
generating teleconference data that includes data associated with display of a group expression graphical element, wherein the group expression graphical element indicates that the indication of the first expression was received from a group of users participating in the teleconference session; and
causing a display, on one or more display devices associated with one or more of the client computing devices, of the teleconference data including the group expression graphical element.

18. The method of claim 17, where causing the display of the teleconference data comprises changing a display characteristic of the group expression graphical element based, at least in part, on the number of the computing devices.

19. The method of claim 18, wherein changing the display characteristic includes changing one or more of an animation effect, a size, or a display color associated with the group expression graphical element.

20. The method of claim 17, wherein causing the display of the teleconference data includes displaying first graphical data associated with a first user for a first period of time and displaying second graphical data associated with a second user for a second period of time.
